(19) United States
(12) Patent Application Publication
(10) Pub. No.: US 2026/0192862 A1
(43) Pub. Date: Jul. 9, 2026

(54) VEHICLE FRAME STRUCTURE

(71) Applicant: TOYOTA JIDOSHA KABUSHIKI KAISHA, Toyota-shi (JP)

(72) Inventors: Shigenori HASHIDA, Nisshin-shi (JP); Kohei NODA, Toyota-shi (JP)

(21) Appl. No.: 19/403,187

(22) Filed: Nov. 27, 2025

(30) Foreign Application Priority Data
Jan. 7, 2025 (JP) 2025-002425

(51) Int. Cl. B62D 25/20; B60R 22/22; B62D 25/08

(52) U.S. Cl. CPC B62D 25/2027; B60R 22/22; B62D 25/08

(57) ABSTRACT

A vehicle frame structure including: a frame-shaped rear section frame main body portion that is integrally formed by casting to include a front section cross portion, a rear section cross portion, and a left and right pair of side member portions that connect end portions of the front section cross portion and the rear section cross portion to each other in a vehicle front-rear direction; a front-rear coupling portion that is disposed further toward a vehicle width direction inner side than the side member portions in the rear section frame main body portion and that connects the front section cross portion and the rear section cross portion in the vehicle front-rear direction; and a belt attachment portion that is provided at the front-rear coupling portion and to which a seatbelt is fixed.

### CROSS-REFERENCE TO RELATED APPLICATION

This application is based on and claims priority under 35 USC 119 from Japanese Patent Application No. 2025-002425 filed on January 7, 2025, the disclosure of which is incorporated by reference herein.

### BACKGROUND

### Technical Field

The present disclosure relates to a vehicle frame structure.

### Related Art

Japanese Patent Application Laid-Open (JP-A) No. 2012-126369 discloses an underbody structure of a vehicle configured to include side members and cross members.

In a case in which the structure that is described in Japanese Patent Application Laid-Open (JP-A) No. 2012-126369 is integrally formed by casting, a belt attachment position of a rear seat cannot be established at a front, and thus, there is room for improvement from the perspective of suppressing a submarine effect.

### SUMMARY

An object of the present disclosure is to obtain a vehicle frame structure in which a belt attachment position of a rear seat can be established at a vehicle front side in a structure in which a frame is formed by casting.

A vehicle frame structure according to a first aspect includes: a frame-shaped rear section frame main body portion that is integrally formed by casting to include a front section cross portion that connects rear end portions of rear wheelhouse portions to each other in a vehicle width direction, a rear section cross portion that is positioned further toward a vehicle rear side than the front section cross portion and that extends in the vehicle width direction, and a left and right pair of side member portions that connect end portions of the front section cross portion and the rear section cross portion to each other in a vehicle front-rear direction; a front-rear coupling portion that is disposed further toward a vehicle width direction inner side than the side member portions in the rear section frame main body portion and that connects the front section cross portion and the rear section cross portion in the vehicle front-rear direction; and a belt attachment portion that is provided at the front-rear coupling portion and to which a seatbelt is fixed.

In the vehicle frame structure according to the first aspect, the rear end portions of the rear wheelhouse portions are connected in the vehicle width direction by the front section cross portion, and the rear section cross portion is disposed further toward the vehicle rear side than the front section cross portion. Further, end portions of the front section cross portion and the rear section cross portion are connected in the vehicle front-rear direction by the left and right pair of side member portions. Furthermore, the rear section frame main body portion is integrally formed by casting to include the front section cross portion, the rear section cross portion, and the side member portions. By forming the rear section frame main body portion by casting in this manner, a number of components and a number of manufacturing steps can be reduced compared to a case in which a rear section frame is configured as separate bodies by steel plates or the like.

Further, the front-rear coupling portion is disposed further toward the vehicle width direction inner side than the side member portions, and the front section cross portion and the rear section cross portion are connected in the vehicle front-rear direction by the front-rear coupling portion. Furthermore, the belt attachment portion to which the seatbelt is fixed is provided at the front-rear coupling portion. By providing the belt attachment portion at the front-rear coupling portion in this manner, a belt attachment position of a rear seat can be established further toward the vehicle front side, compared to a configuration in which the front-rear coupling portion is not provided and a configuration in which the belt attachment portion is not provided at the front-rear coupling portion.

A vehicle frame structure according to a second aspect is the vehicle frame structure according to the first aspect, wherein the front-rear coupling portion is integrally formed by casting together with the front section cross portion, the rear section cross portion, and the side member portions.

In the vehicle frame structure according to the second aspect, since the front-rear coupling portion is integrally formed with the front section cross portion, the rear section cross portion, and the side member portions, a load that has been input from the seatbelt to the belt attachment portion can be effectively transmitted to the front section cross portion and the rear section cross portion.

A vehicle frame structure according to a third aspect is the vehicle frame structure according to the first aspect, wherein a left and right pair of front-rear coupling portions are provided, and the belt attachment portion is provided at each of the front-rear coupling portions.

In the vehicle frame structure according to the third aspect, since the seatbelt can be fixed to the left and right front-rear coupling portions, a load that is input from the seatbelt can be distributed to the left and right.

A vehicle frame structure according to a fourth aspect is the vehicle frame structure according to the first aspect, wherein plural ribs that extend in the vehicle width direction at intervals in the vehicle front-rear direction are provided at the front-rear coupling portion.

In the vehicle frame structure according to the fourth aspect, the front-rear coupling portion can be reinforced by the ribs.

A vehicle frame structure according to a fifth aspect is the vehicle frame structure according to any one of the first aspect to the fourth aspect, wherein plural belt attachment portions are provided at the front-rear coupling portion.

In the vehicle frame structure according to the fifth aspect, the vehicle frame structure can also be applied to other vehicle types in which positions of rear seats in the front and rear direction are different.

As explained above, the vehicle frame structure according to the present disclosure enables a belt attachment position of a rear seat to be established at a vehicle front side.

### BRIEF DESCRIPTION OF THE DRAWINGS

An exemplary embodiment of the present disclosure will be described in detail based on the following figures, wherein:

FIG. 1 is a perspective view illustrating relevant portions of a vehicle frame structure according to an exemplary embodiment;

FIG. 2 is an enlarged perspective view of a front portion of a front-rear coupling portion in the exemplary embodiment; and

FIG. 3 is an enlarged perspective view of a rear portion of the front-rear coupling portion in the exemplary embodiment.

### DETAILED DESCRIPTION

A vehicle frame structure according to an exemplary embodiment will be explained with reference to the drawings.

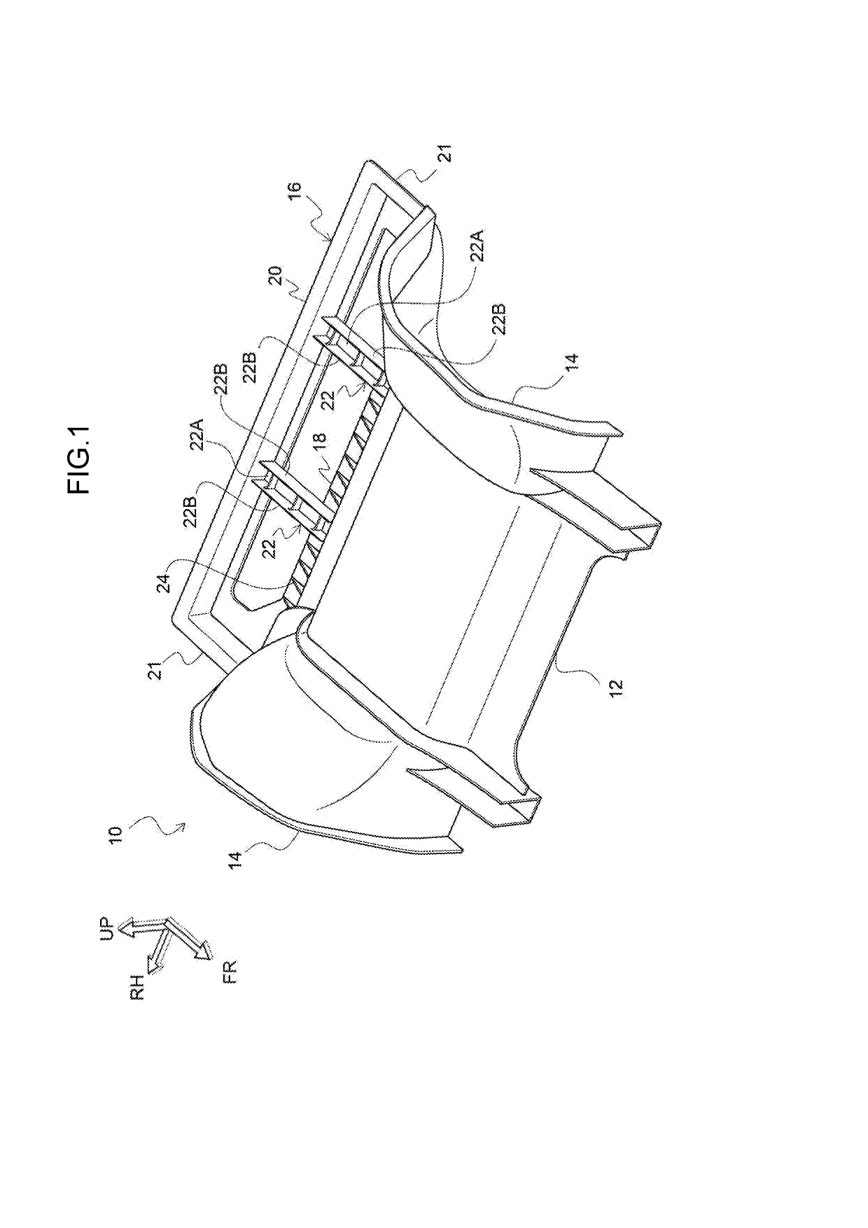

FIG. 1 is a perspective view illustrating relevant portions of the vehicle frame structure according to the exemplary embodiment. It should be noted that, in the drawings, arrow FR, arrow UP, and arrow RH respectively indicate a vehicle frontward direction, a vehicle upward direction, and a vehicle rightward direction of a vehicle. Unless specifically stated otherwise, in cases in which front and rear, up and down, and left and right directions are used in the following explanation, these respectively refer to front and rear in a vehicle front-rear direction, up and down in a vehicle up-down direction, and left and right in a vehicle left-right direction (width direction).

As illustrated in FIG. 1, a rear section frame main body portion 10 configuring the vehicle frame structure is a component that is disposed at a rear section of the vehicle, and is formed by casting. The rear section frame main body portion 10 of the present exemplary embodiment is a die-cast component that is integrally formed by casting so as to include a rear floor portion 12, rear wheelhouse portions 14, and a frame-shaped frame portion 16.

The rear floor portion 12 extends in the vehicle width direction and the vehicle front-rear direction, and configures a rear section floor of the vehicle. Further, the rear wheelhouse portions 14 are provided at both vehicle width direction sides of the rear floor portion 12.

The rear wheelhouse portions 14 are each formed in a shape that bulges toward a vehicle width direction inner side, and a rear wheel, which is not illustrated in the drawings, is disposed at an inner side of each of the rear wheelhouse portions 14. Further, a center floor portion, which is not illustrated in the drawings, is disposed at a vehicle front side of the rear floor portion 12 and the rear wheelhouse portions 14.

The frame-shaped frame portion 16 is provided further toward a vehicle rear side than the rear wheelhouse portions 14, and the frame-shaped frame portion 16 is configured substantially in a frame shape in plan view so as to include a front section cross portion 18, a rear section cross portion 20, side member portions 21, and front-rear coupling portions 22.

The front section cross portion 18 extends in the vehicle width direction, and connects rear ends of the rear wheelhouse portions 14 to each other. Plural reinforcing ribs 24 are provided at intervals in the vehicle width direction at the front section cross portion 18.

The rear section cross portion 20 is disposed further toward the vehicle rear than the front section cross portion 18. The rear section cross portion 20 extends in the vehicle width direction substantially parallel to the front section cross portion 18, and is formed with a length in the vehicle width direction that is longer than that of the front section cross portion 18.

Both vehicle width direction end portions of the front section cross portion 18 and both vehicle width direction end portions of the rear section cross portion 20 are connected by the side member portions 21. Each of the side member portions 21 extends in the vehicle front-rear direction, and a front end portion of the side member portion 21 is connected to a rear wheelhouse portion 14 together with the front section cross portion 18. A frame having a substantially rectangular frame shape in plan view is formed by the front section cross portion 18, the rear section cross portion 20, and the side member portions 21.

The front-rear coupling portions 22 are disposed further toward the vehicle width direction inner side than the side member portions 21. The front-rear coupling portions 22 extend in the vehicle front-rear direction, and front end portions of the front-rear coupling portions 22 are connected to the front section cross portion 18. Further, rear end portions of the front-rear coupling portions 22 are connected to the rear section cross portion 20.

Furthermore, although a left and right pair of the front-rear coupling portions 22 are provided and the front-rear coupling portions 22 are disposed at positions that substantially equally divide an area between the left and right side member portions 21 in the present exemplary embodiment as an example, there is no limitation thereto, and the front-rear coupling portions 22 may be provided at other positions.

Each front-rear coupling portion 22 is configured to include a bottom wall portion 22A extending in the vehicle front-rear direction with a plate thickness direction thereof being along the vehicle up-down direction, and side wall portions 22B that respectively extend out toward the vehicle upper side from both vehicle width direction end portions of the bottom wall portion 22A. That is to say, the front-rear coupling portion 22 is formed so that a cross-section thereof as viewed from the vehicle front-rear direction is substantially a U-shape that is open at the vehicle upper side.

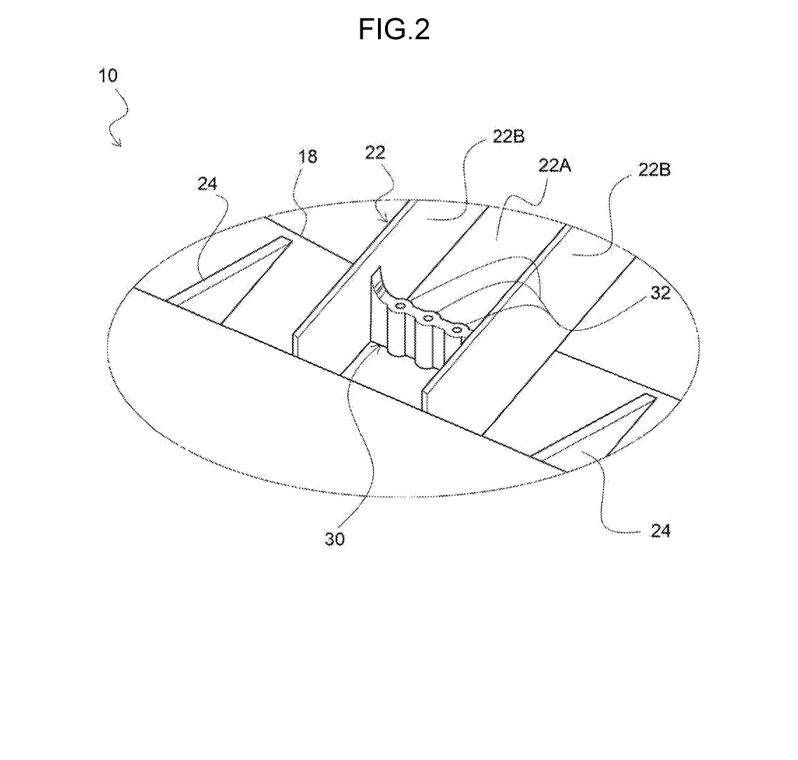

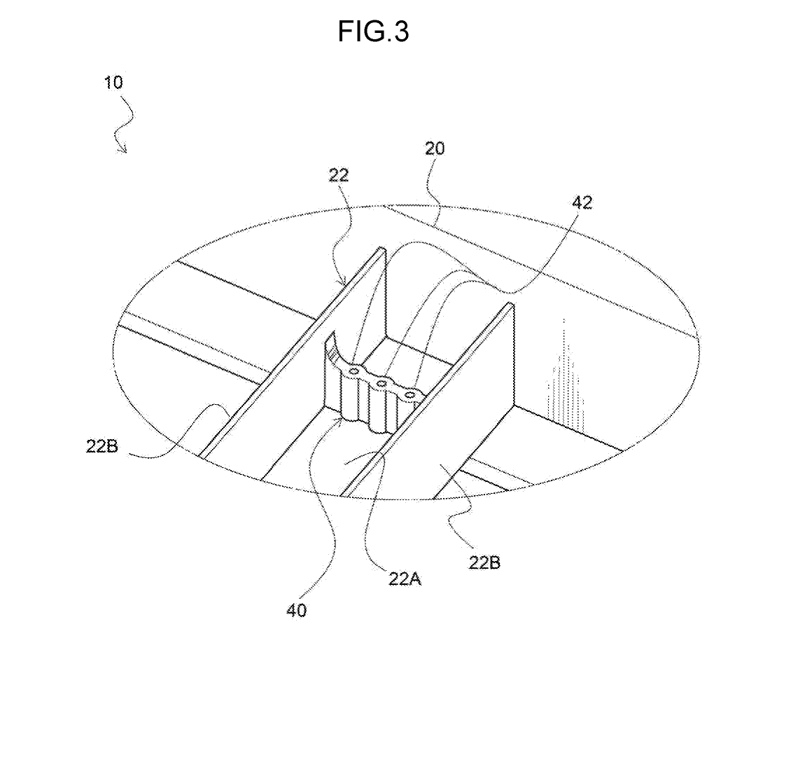

Further, plural ribs are formed at intervals in the vehicle front-rear direction at the front-rear coupling portion 22. FIG. 2 is an enlarged perspective view of a front portion of the front-rear coupling portion 22 in the exemplary embodiment, and FIG. 3 is an enlarged perspective view of a rear portion of the front-rear coupling portion 22 in the exemplary embodiment.

As illustrated in FIG. 2, front side belt attachment portions 32 are formed at a front side rib 30 that is formed at the front portion of the front-rear coupling portion 22. The front side belt attachment portions 32 are portions to which a seatbelt that is established at a rear seat are fixed.

The front side rib 30 extends in the vehicle width direction with a plate thickness direction thereof being along the vehicle front-rear direction, and a right side end portion of the front side rib 30 is connected to a side wall portion 22B that is at the vehicle right side. Further, a left side end portion of the front side rib 30 is connected to a side wall portion 22B that is at the vehicle left side.

Each front side belt attachment portion 32 is configured by a columnar portion that is formed at the front side rib 30, and in the present exemplary embodiment, three front side belt attachment portions 32 are provided as an example. Attachment holes that are open at the vehicle upper side are respectively formed at the front side belt attachment portions 32, and anchors for fixing the seatbelt are respectively fixed at the attachment holes.

As illustrated in FIG. 3, rear side belt attachment portions 42 are formed at a rear side rib 40 that is formed at the rear portion of the front-rear coupling portion 22. The rear side belt attachment portions 42 are portions to which the seatbelt that is established at the rear seat are fixed.

The rear side rib 40 extends in the vehicle width direction with a plate thickness direction thereof being along the vehicle front-rear direction, and a right side end portion of the rear side rib 40 is connected to the side wall portion 22B that is at the vehicle right side. Further, a left side end portion of the rear side rib 40 is connected to the side wall portion 22B that is at the vehicle left side.

Each rear side belt attachment portion 42 is configured by a columnar portion that is formed at the rear side rib 40, and in the present exemplary embodiment, three rear side belt attachment portions 42 are provided as an example. Attachment holes that are open at the vehicle upper side are respectively formed at the rear side belt attachment portions 42, and anchors for fixing the seatbelt are respectively fixed at the attachment holes.

Thus, in the present exemplary embodiment, the front side belt attachment portions 32 and the rear side belt attachment portions 42 are provided at the front-rear coupling portion 22. That is to say, plural belt attachment portions are provided with respect to one front-rear coupling portion 22.

Further, in the present exemplary embodiment, belt attachment portions are provided at each of the left and right front-rear coupling portions 22. Thus, the seatbelt at the vehicle right side of the rear seat is fixed to the belt attachment portions at the right side, and the seatbelt at the vehicle left side is fixed to the belt attachment portions at the left side.

### Operation

Next, operation of the vehicle frame structure according to the present exemplary embodiment will be explained.

As illustrated in FIG. 1, in the present exemplary embodiment, rear end portions of the rear wheelhouse portions 14 are connected to each other in the vehicle width direction by the front section cross portion 18, and the rear section cross portion 20 is disposed further toward the vehicle rear than the front section cross portion 18. Further, end portions of the front section cross portion 18 and the rear section cross portion 20 are connected in the vehicle front-rear direction by the left and right pair of side member portions 21. Furthermore, the rear section frame main body portion 10 is integrally formed by casting so as to include the front section cross portion 18, the rear section cross portion 20, and the side member portions 21. By forming the rear section frame main body portion 10 by casting in this manner, a number of components and a number of manufacturing steps can be reduced compared to a case in which a rear section frame is configured as separate bodies by steel plates or the like.

Further, the front-rear coupling portions 22 are disposed further toward the vehicle width direction inner side than the side member portions 21, and the front section cross portion 18 and the rear section cross portion 20 are connected in the vehicle front-rear direction by the front-rear coupling portions 22. Moreover, as illustrated in FIG. 2 and FIG. 3, the front side belt attachment portions 32 and the rear side belt attachment portions 42 to which the seatbelt is fixed are provided at each front-rear coupling portion 22. By providing the front side belt attachment portions 32 and the rear side belt attachment portions 42 at the front-rear coupling portion 22 in this manner, a belt attachment position of the rear seat can be established further toward the vehicle front side, compared to a configuration in which the front-rear coupling portion 22 is not provided and a configuration in which the belt attachment portions are not provided at the front-rear coupling portion 22.

Furthermore, in the present exemplary embodiment, since the front-rear coupling portions 22 are integrally formed with the front section cross portion 18, the rear section cross portion 20, and the side member portions 21, a load that has been input from the seatbelt to the front side belt attachment portions 32 and the rear side belt attachment portions 42 can be effectively transmitted to the front section cross portion 18 and the rear section cross portion 20.

Moreover, in the present exemplary embodiment, since the seatbelt can be fixed to the left and right front-rear coupling portions 22, a load that is input from the seatbelt can be distributed to the left and right.

Further, in the present exemplary embodiment, since the front side rib 30 and the rear side rib 40 are provided at the front-rear coupling portion 22, the front-rear coupling portion 22 can be reinforced by these ribs.

Furthermore, in the present exemplary embodiment, since the belt attachment portions are provided at each of the front portion and the rear portion of the front-rear coupling portion 22, the present disclosure can also be applied to other vehicle types in which positions of rear seats in the front and rear direction are different.

Although a vehicle frame structure according to the present disclosure has been explained above, it goes without saying that various embodiments can be implemented in a range that does not depart from the spirit of the present disclosure. For example, although the left and right pair of front-rear coupling portions 22 are provided in the present exemplary embodiment as illustrated in FIG. 1, there is no limitation thereto, and a configuration may be provided in which a single front-rear coupling portion 22 is provided.

Further, although the front-rear coupling portions 22 are integrally formed by casting together with the front section cross portion 18, the rear section cross portion 20, and the side member portions 21 in the present exemplary embodiment, there is no limitation thereto. For example, a front-rear coupling portion may be prepared as a separate body and installed so as to span between the front section cross portion 18 and the rear section cross portion 20.

Furthermore, although the front side belt attachment portions 32 and the rear side belt attachment portions 42 are provided at the front-rear coupling portions 22 in the present exemplary embodiment, there is no limitation thereto, and a configuration may be provided in which a single belt attachment portion is provided.

With regard to the above-described exemplary embodiment, the following additional notes are further disclosed.

### Additional Note 1

A vehicle frame structure including:

a frame-shaped rear section frame main body portion that is integrally formed by casting to include a front section cross portion that connects rear end portions of rear wheelhouse portions to each other in a vehicle width direction, a rear section cross portion that is positioned further toward a vehicle rear side than the front section cross portion and that extends in the vehicle width direction, and a left and right pair of side member portions that connect end portions of the front section cross portion and the rear section cross portion to each other in a vehicle front-rear direction;

a front-rear coupling portion that is disposed further toward a vehicle width direction inner side than the side member portions in the rear section frame main body portion and that connects the front section cross portion and the rear section cross portion in the vehicle front-rear direction; and

a belt attachment portion that is provided at the front-rear coupling portion and to which a seatbelt is fixed.

### Additional Note 2

The vehicle frame structure according to Additional Note 1, wherein the front-rear coupling portion is integrally formed by casting together with the front section cross portion, the rear section cross portion, and the side member portions.

### Additional Note 3

The vehicle frame structure according to Additional Note 1 or Additional Note 2, wherein a left and right pair of front-rear coupling portions are provided, and the belt attachment portion is provided at each of the front-rear coupling portions.

### Additional Note 4

The vehicle frame structure according to any one of Additional Note 1 to Additional Note 3, wherein plural ribs that extend in the vehicle width direction at intervals in the vehicle front-rear direction are provided at the front-rear coupling portion.

### Additional Note 5

The vehicle frame structure according to any one of Additional Note 1 to Additional Note 4, wherein plural belt attachment portions are provided at the front-rear coupling portion.

What is claimed is:

1. A vehicle frame structure comprising:
a frame-shaped rear section frame main body portion that is integrally formed by casting to include a front section cross portion that connects rear end portions of rear wheelhouse portions to each other in a vehicle width direction, a rear section cross portion that is positioned further toward a vehicle rear side than the front section cross portion and that extends in the vehicle width direction, and a left and right pair of side member portions that connect end portions of the front section cross portion and the rear section cross portion to each other in a vehicle front-rear direction;
a front-rear coupling portion that is disposed further toward a vehicle width direction inner side than the side member portions in the rear section frame main body portion and that connects the front section cross portion and the rear section cross portion in the vehicle front-rear direction; and
a belt attachment portion that is provided at the front-rear coupling portion and to which a seatbelt is fixed.

2. The vehicle frame structure according to claim 1, wherein the front-rear coupling portion is integrally formed by casting together with the front section cross portion, the rear section cross portion, and the side member portions.

3. The vehicle frame structure according to claim 1, wherein a left and right pair of front-rear coupling portions are provided, and the belt attachment portion is provided at each of the front-rear coupling portions.

4. The vehicle frame structure according to claim 1, wherein a plurality of ribs that extend in the vehicle width direction at intervals in the vehicle front-rear direction are provided at the front-rear coupling portion.

5. The vehicle frame structure according to claim 1, wherein a plurality of belt attachment portions are provided at the front-rear coupling portion.
